(19) United States
(12) Patent Application Publication
(10) Pub. No.: US 2005/0059334 A1
(43) Pub. Date: Mar. 17, 2005

(54) LEG PROCESSOR YIELD IMPROVEMENT

(75) Inventors: Brandon C. Haley, Springdale, AR (US); Marshall Vanderpool, Bentonville, AR (US); Kelvin D. Lasse, Springdale, AR (US)

Correspondence Address: BLACKWELL SANDERS PEPER MARTIN LLP, 720 OLIVE STREET, SUITE 2400, ST. LOUIS, MO, 63101, US

(73) Assignee: TYSON FOODS, INC., Springdale, AR (US)

(21) Appl. No.: 10/605,185

(22) Filed: Sep. 12, 2003

(51) Int. Cl. A22C 18/00

(52) U.S. Cl. 452/167

(57) ABSTRACT

The invention is a method and apparatus for improving the yield value of leg processing machines by increasing the amount of skin and flesh removed with the back portion. The leg processing method and apparatus of the present invention improves processing of the poultry back half or saddle portion of the carcass. The present invention generates a yield value increase for whole legs or back-out. The present invention is an apparatus which includes a combination of a hold down bar, guide members, blades, and plowing members which effect a yield value increase for the whole leg by increasing the amount of flesh and skin removed from the back portion and left attached to the upper thigh portion of the whole leg.

### BACKGROUND OF INVENTION

This invention relates generally to processing poultry carcass parts and, more particularly, relates to processing poultry legs and back portions sometimes referred to as “back halves” or “saddles”.

There are machines that harvest whole leg or back-out thighs from a poultry carcass. These leg processing machines process the “back half” or the “saddle” of the poultry carcass. Please note that the saddle and the back half describe the same portion of the carcass which includes the two leg quarters and the lower back spine portion of the carcass. Leg processing machines have been designed to separate the two leg quarters from the back portion of the saddle. The separation is made at the thigh joints of the birds, which connects the thigh of the whole leg to the back portion. Designing a mechanism to effectively perform this function is difficult because of the dense muscles and tough tendons that hold the thigh joints to the back portion.

Various devices are used which make an incision along the spine towards the thigh joint thereby severing the whole leg from the back portion of the carcass. Many of the machine designs include mechanisms which grasp and capture the hock joint ends of the leg and pull outward against the leg causing tension at the thigh joint, in addition to cutting, thereby separating the leg quarter from the back portion along the incision made along the spine downward toward the thigh joint. However, many of these machines have an undesirable yield value in that a higher than desired amount of flesh and skin is left on the back portion of the carcass along the spine. The skin and flesh that remains on the back portion along the spine is sold at a much lower value than if that same portion of skin and flesh is separated as part of the whole leg. Separating more skin and flesh with the whole leg increases the weight of the whole leg and also increases the yield value of the skin and flesh that would otherwise be left on the back portion.

The back portion of the poultry carcass refers to the lower spine and pelvic area of the carcass which is sold at a much lower value per ounce than the whole leg. The traditional leg processing machines leave a strip of skin and flesh that covers the spine which should be removed along with the whole leg. The traditional leg processing machines include a hold down bar which applies pressure to the spine of the saddle while the legs are removed from the back portion. The hold down bars are typically utilized with a combination of blades and guide members to guide the saddle and sever the leg quarters from the back portion. The guide members are utilized to properly align the saddle as it passes over cutting blades which severs the tissue that holds the bones of the joints together at the thigh and the back portion of the carcass. The tissue surrounding the bones of the joint of the thigh and the back must be cut to open the joint and once this cut is performed the leg quarters are typically rotated to twist the socket that connects the back portion with the thigh thereby separating the leg quarter.

As discussed above it is desirable for more flesh and skin to be left on the thighs rather than the back portion. Poultry processors sell the back portion at a lower price per pound than the whole leg which in many cases the whole leg is roughly sold at twenty times the price per pound than the back portion. An invention is needed that increases the yield value of leg processing machines which improves the design of the guide members and hold down bar and cutting members such that additional skin and flesh is removed with the whole leg as opposed to being left on the back portion.

### SUMMARY OF INVENTION

The invention is a method and apparatus for improving the yield value of leg processing machines by increasing the amount of skin and flesh removed with the back portion. The leg processing method and apparatus of the present invention improves processing of the poultry back half or saddle portion of the carcass. The present invention generates a yield value increase for whole legs or back-out thighs. The present invention is an apparatus which includes a combination of a hold down bars, guide members, blades, and plowing members which effect a yield value increase for the whole leg by increasing the amount of flesh and skin removed from the back portion and left attached to the upper thigh portion of the whole leg.

The improvements of the present invention over the prior art create a yield increase. The new hold down bar also referred to as the upper guide assembly as combined with other elements of the invention does not generate meat or skin that was not already being harvested. Thus, within processing, the correct terminology to use is a “yield value increase”. The present invention creates a value increase in how the skin is harvested with the whole leg rather than the back portion.

The present invention utilizes a specially designed guide bar, blade, and plow combination for severing, separating and pulling the whole leg from the back portion. The apparatus also includes an elongated plow member having a circular or curved bend and a triangular wedge or v-shaped cross section plow. The plow member is utilized to effect separation of the skin and flesh covering the spine area of the back portion.

These and other advantageous features of the present invention will be in part apparent and in part pointed out herein below.

### BRIEF DESCRIPTION OF DRAWINGS

For a better understanding of the present invention, reference may be made to the accompanying drawings in which

FIG. 1 is a perspective view of the leg processing apparatus;

FIG. 2 is a perspective view of the disc and butterfly secondary upper guide member end or exit end of the leg processing apparatus;

FIG. 2a is an isometric view of the curved plow having a v-shaped cross section;

FIG. 3 is a perspective view of the product entry end of the leg processing apparatus;

FIG. 3a is a perspective view of the lower guide assembly;

FIG. 4 is a side view of the exit end of the leg processing apparatus;

FIG. 5 is a perspective view of the plow area;

FIG. 6 is a perspective view of the leg processing apparatus having a back half hanging in a shackle being conveyed through the leg processor;

FIG. 7 is a perspective view of the arrangement between the curved plow and disc;

FIG. 7a is a side view of the arrangement between the curved plow, disc, and secondary upper guide assembly;

FIG. 8 is an isometric view of the guide rods of the secondary upper guide assembly.

### DETAILED DESCRIPTION

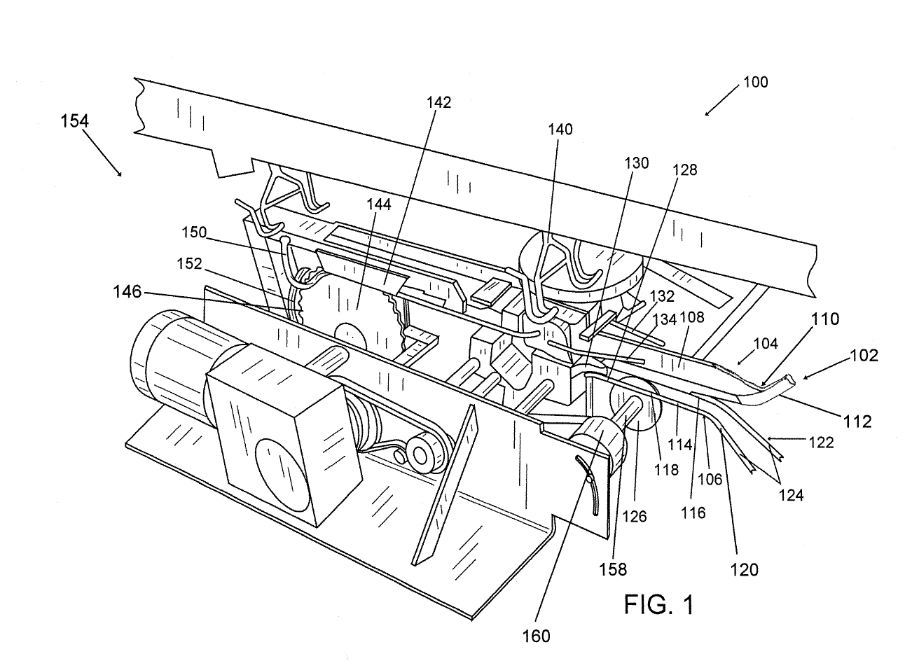

According to the embodiment(s) of the present invention, various views are illustrated in FIG. 1-8 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a combination of guide members, cutting blades and plows teaches a novel apparatus and method for processing the saddle portion of a poultry carcass to effectively maximize the amount of skin and flesh removed from the back portion with the whole leg.

The details of the invention and various embodiments can be better understood by referring to the figures of the drawing. Referring to FIG. 1, a front side view of the leg processor 100 is shown. On the entry end 102 of the leg processor 100 there are two guide assemblies, an upper 104 and lower guide assembly 106. The upper guide assembly comprises an elongated member 108 having a v-shaped cross section and also having an upward bend 110 in the member on the product entry side 112 of the guide member 108. The lower guide assembly 106 comprises two elongated guide members or rods 114 and 116 extending in parallel along a portion 118 of the rod and the two members have coincident downward bends 120 toward the product entry side 122 of the lower guide assembly 106 and the portion 124 of the rods having a downward bend also are angled outward away from each other. The upper and lower guide assemblies are adapted to receive the back portion of the back half there between. The portion 118 of the rods extending adjacent and parallel to one another each are positioned on opposing sides of a circular blade 126 which is adapted to sever the back half along the spine of the back portion. The parallel portions 118 of the guide rods extend beyond the circular blade on the other side 128 of the blade from the entry end, which can also be referred to as the exit side of the lower guide assembly. The two parallel portions of the rod extend to connect to a wedge shaped or v-shaped plow member 130 where each leg of the v-shaped plow is connected to one of the elongated rod members. A solid triangular wedge or similar wedge will also work with either side of the wedge attached to one of the adjacent guide rods 114 and 116.

The upper guide assembly has an angled portion of the assembly that is angled upward away from the lower guide assembly, which is the product entry side 112 of the upper guide assembly, such that an appropriate opening is provided between the upper and lower guide members such that the back half of the poultry carcass can be received therebetween. The apparatus is designed such that the back portion of the back half or saddle is received under the upper guide assembly and the leg quarters straddle the upper guide assembly. The v-shaped cross section of the upper guide assembly is inverted with the peak or crest edge downward such that either side of the v-shaped cross member engages the carcass portion and centers the back portion about the crest edge. The upper guide assembly tends to spread the legs outward creating a tension in the tissues and muscles of the tendons surrounding the thigh joint for providing adequate access and positioning for the circular cutting member. The upper guide assembly also has outwardly angled rod members 132 and 134, which further spread the legs apart.

The lower guide assembly supports the underside of the carcass portion and positions the back half at the appropriate height such that it is severed along the spine by the circular blade 126. The downward bend and the outward angled separation portion 124 of the rod members 114 and 116 on the entry end of the lower guide assembly also are designed to provide adequate clearance such that the carcass back half portion can be received between the upper and lower guide assemblies. The v-shaped plow member 130 attached on the exit end of the lower guide assembly is designed to align its peak or crescent edge with the cutting edge of the circular blade such that the outward angled diverging sides of the plow will further the separation of the skin and flesh along the spine to assist in the separation of the whole leg from the back portion. The circular blade 126 is rotatable about axle 158 and is driven by drive 160.

The conveyor shackles 140 continue to pull the back half carcass portion through the leg processor assembly and positions the carcass portion such that the legs straddle a secondary upper guide assembly 142, which further spreads the legs apart for engaging the back half with subsequent cutting blades for finalizing the cut and severing of the whole leg from the back portion. The secondary upper guide assembly 142 guides the carcass portion into a disc 144 having radially extending teeth 146 around its periphery forming a saw tooth like edge for grabbing the back of the carcass portion. The disc having teeth grabs the carcass portion and pulls it downward along its circumference and passing the outward extending butterfly wing portions of secondary guide rods 150 of the secondary upper guide assembly. The secondary upper guide assembly having rod members 150 is designed such that on the exit end 154 of the assembly the rod members transition to extend outward away from one another forming a pair of outwardly extending looped butterfly wing like structures, which further pull the leg portions apart for separating the leg quarter from the back portion. The exit end 154 is downstream from the entry end 102 along the path of conveyance just as the secondary upper guide assembly 142 is downstream from upper guide assembly 104. In addition to the pulling action caused by the outwardly extending looped butterfly wing like structures of the secondary guide rods 150, the back portion is grabbed and pulled by the disc to engage an elongated circular or curved plow 152 having a v-shaped cross section, which assists in completing the separation of the whole leg from the back portion. The circular or curved elongated plow 152 extends in a co-centric manner around a portion of the periphery of the disc such that as the disc pulls the carcass along its circumference the carcass is also pulled along the co-centric plow such that the spine area or keel of the back portion engages the plow along the cut thereby completing the separation of the legs from the back portion. The curved plow 152 need not be co-centric with the disc, which is dependent upon the application.

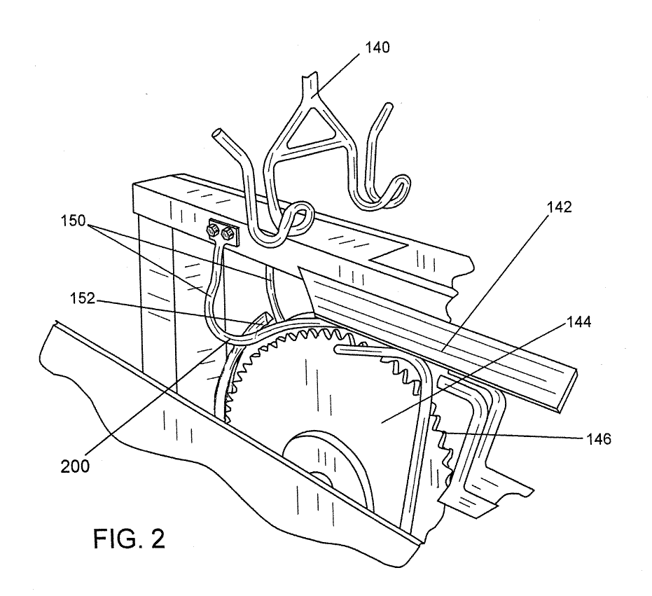

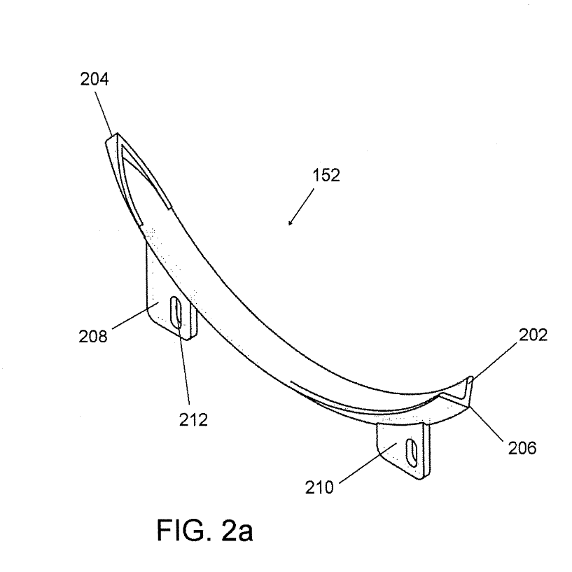

Referring to FIG. 2, an isometric view of the exit end of the leg processor is shown. The secondary upper guide assembly 142 is shown having two elongated rod members 200 that extend substantially parallel to each other and then on the exit end turn downward around the periphery of the disc and then curve downward and outward and away from each other and then inward and upward toward each other forming a butterfly wing structure 150 that is designed to further pull the legs apart in order to further the separation of the leg quarter from the back portion. The two rod members 200 straddle circular or curved plow 152 having a v-shaped cross section. The secondary upper guide member assembly guides the carcass portion along the circumference of the disc and further guides the carcass portion to engage the teeth the curved plow. The disc grabs the carcass portion and pulls it downward along the circular plow to complete the separation of the leg quarters from the back portion. The secondary upper guide assembly could comprise guide members other than the guide rods, which guide the back half in the same manner.

There is a combination of the pulling action which separates the legs as caused by the butterfly wing portions of the upper secondary guide member assembly with the separation along the spine area caused by the curved co-centric plow member. The combination of the tension caused by the butterfly portion and the plow member results in effecting separation of the leg quarters from the back portion. The butterfly portion and the plow increase the amount of skin and flesh separated from the back portion with the upper thigh of the whole leg. The curved form of the butterfly wing portion may vary depending on the product application. The curved plow may or may not be co-centric depending on the application and the desired resulting plowing action, and the curved plow may or may not have a circular arc. The downward turn of the guide rods also may or may not be co-centric to the disc depending on the application. The height of the shackle with respect to the secondary upper guide assembly is such that the back portion is received and conveyed under the secondary upper guide assembly. The radial distance between the disc and the curved plow may also be adjusted.

Referring to FIG. 2a, an isometric view of the curved plow 152 having a v-shaped cross section 202 is shown. The curved plow is shown having a pointed leading edge 204 to make initial engagement to initiate plowing into the cut along the spine of the back portion. The plow then progressively widens from the leading edge and then extends with a uniform width. The curved plow has a v-shaped cross section such that the plow has a peak or crest edge 206 that extends along its length. It is this peak or crest edge that plows into the cut made along the spine to assist in the separation of the leg quarter from the back portion along with the skin around the keel area. The curved plow is shown with two slotted tab mounts 208 and 210 for adjustably mounting along the slot the curved plow to a frame. The radial distance between the disc having teeth around its peripheral and the curved plow can be adjusted using the slot 212 of the slotted mounting tabs.

When the disc having teeth around its peripheral grasps the back portion and pulls it downward, the back portion is pulled downward to engage the curved plow such that the crest or peak that extends along the plow plows into the cut along the keel area. Adjusting the radial distance between the curved plow and the disc will determine the depth that the plow will plow into the back portion. The plowing action of the curved plow occurs concurrent with the pulling action caused by the secondary upper guide assembly which curve outward forming a butterfly wing like structure. The curved plow assists in separating any skin and tissue from the back portion with the leg quarter that would otherwise remain along the spine of the back portion.

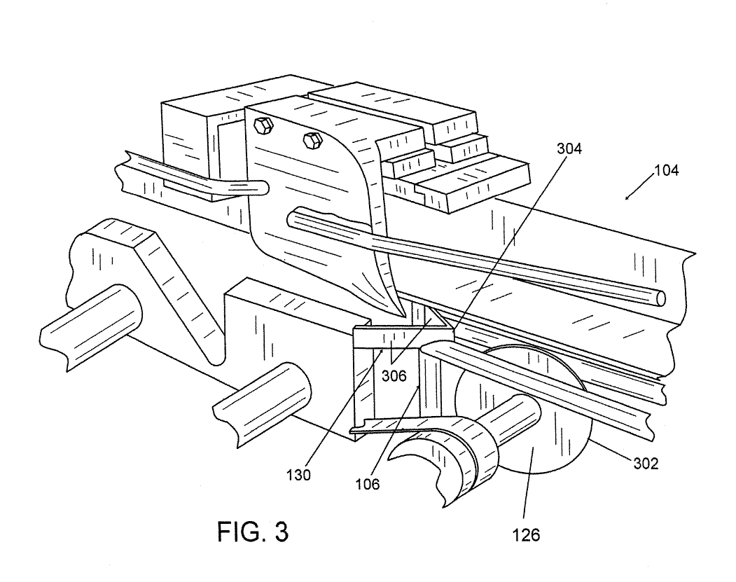

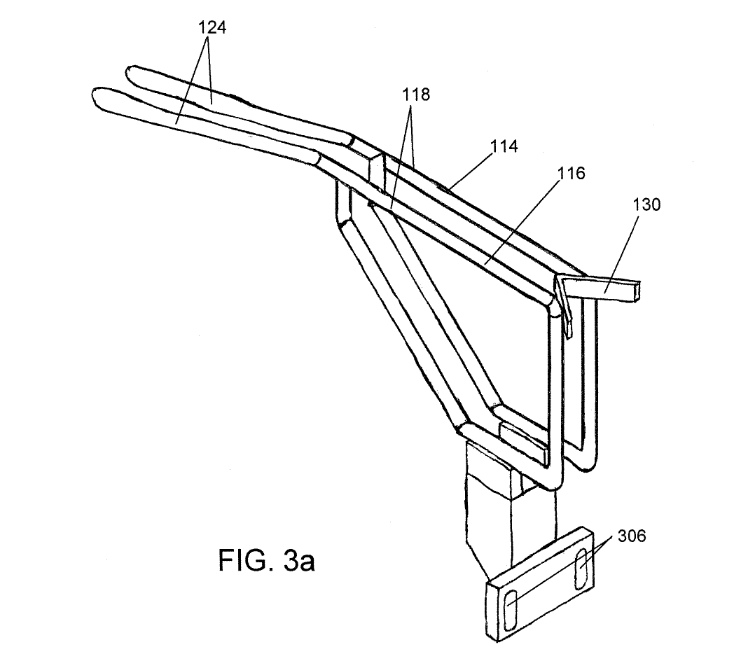

Referring to FIG. 3, an isometric view of the circular blade area of the leg processor is shown. The circular blade 126 is shown oriented vertically such that the blade edge 302 is positioned to sever the carcass portion along the spine. The upper guide assembly 104 holds and guides the back portion downward to engage the edge of the circular blade. The lower guide assembly 106 positions the back at the appropriate height such that the depth of the incision can be controlled. The lower guide assembly is shown having a portion comprising two guide rod members extending in parallel and straddling the circular blade. The exit end of the parallel rod members are connected by a v-shaped plow member 130 whose peak or leading edge 304 is substantially aligned with the edge of the circular blade. This alignment causes the plow to plow along the incision created by the circular blade. The diverging legs 306 of the v-shaped plow are angled outward forming a wedge such that the legs of the back half are further pulled apart for subsequent engaging of blade members. Simply cutting with a circular blade does not provide a progressive separation where the cutting, plowing, actions in combination progressively separates the leg quarter.

FIG. 3a shows an isometric view of the lower guide assembly 106 having left and right elongated rod members 114 and 116. The elongated rod members have a parallel portion 118 and the angled portion 124. The circular blade extends up between the rod members. The rod members cradle the spine of the back portion there between and centrally align the keel at the appropriate height for cutting along the keel by the rotating circular blade, which is driven by a typical motor or drive. The v-shaped plow is attached at the exit end of the guide rod members 114 and 116. The peak or crest edge of the plow is vertically oriented and substantially aligned with edge of the circular blade. The height of the guide rods can be adjusted with mounting slots 306. Adjusting the height of the guide rods will adjust the depth of the cut made by the circular blade.

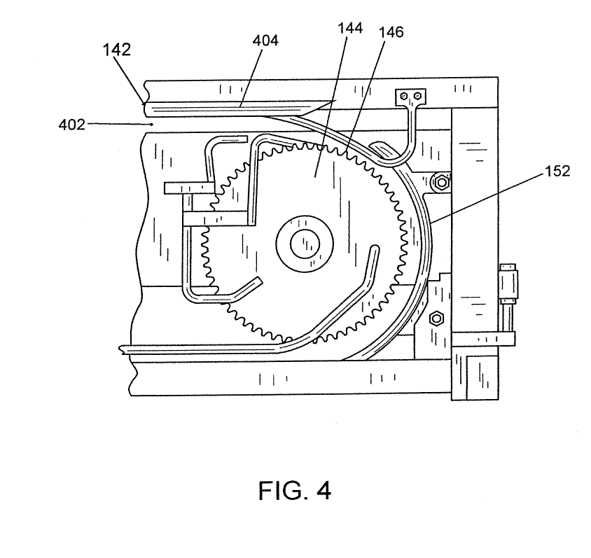

Referring to FIG. 4, a side view of the exit end of the leg processing apparatus is shown. An overhead conveyor rail having a plurality of shackles 140 hanging therefrom, not shown in this view, conveys the back half through the leg processor. The conveyor and shackles pull the carcass portion through a guide channel 402 extending between the upper and lower guide members of the apparatus. The secondary upper and lower guide assemblies are shown which receive the back half portion of the carcass being conveyed downstream along the path of conveyance. At the entry end of the leg processing system there is an upper guide assembly and a lower guide assembly that are vertically spaced apart leaving a gap or channel 402 there between for receiving the incoming carcass portions. In the case of the back half or the saddle, the back portion is conveyed between the upper and lower guide assemblies.

As discussed above the lower guide assembly comprises two elongated rod members that extend in parallel over a portion of their length straddling the circular blade. As the carcass is conveyed through the leg processor the carcass transitions to a secondary upper guide assembly 142 having an outwardly and downwardly angled side fin 404 on either side which guides the back of the carcass to engage the disc 144 having peripheral teeth 146 for grabbing the carcass in the back area and pulling downward to engage the curved plow member 152.

Prior to engaging the disc having peripheral teeth the carcass engages a plurality of blades designed to sever the leg quarters from the back portion. The leg processor is powered by a group of motors or drives operatively attached to various components such as the circular blade and the disc. The entire leg processing assembly is mounted into a frame along the conveyor line and extending along the path of conveyance. As the carcass is conveyed along the leg processor the carcass portion is first cut by a circular blade and then plowed by a v-shaped plow member and then cut by a series of blades and then captured by the disc and pulled downward to engage the co-centric elongated plow having a v-shaped cross section as the legs are pulled outward by the butterfly like guide rods. Once the legs have been completely separated from the back portion the back portion falls downward for gathering and the legs remain in the conveyor shackles and are conveyed down the conveyance line for further processing.

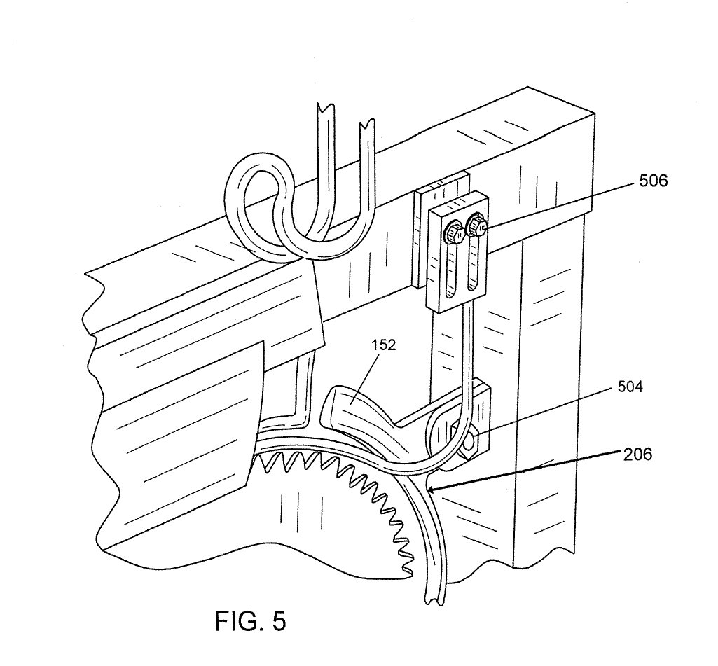

Referring to FIG. 5, a perspective view of the curved plow 152 is shown. The curved plow is an elongated member having a v-shaped cross section that forms an arc that is shown co-centric with the disc and is proximately spaced from the teeth of the disc extending around the peripheral of the disc and leaving a gap there between. The plow forming an arc extends around a portion of the disc peripheral. The plow is mounted to a frame structure such that it can be adjustably positioned with respect to the disc. As the disc rotates as driven by a motor or drive and engages its teeth in the back portion of a carcass, the carcass is pulled into the curved plow and the back portion of the carcass is pulled along the plow such that the v-shaped cross section furthers the separation of the legs from the back portion. The crest or peak of the v-shaped cross section forms a crest edge 206 along the length of the plow and the ridge or crest edge is aligned such that the ridge engages the cuts along the back side of the carcass that were made to separate the legs from the back portion. Engaging these cuts with the plow member furthers the separation of the legs from the back portion. As the plow is plowing and the carcass is conveyed along the guide rods, the butterfly wing like structure of the rods are pulling the legs apart thereby effecting separation of the legs from the back portion along the cuts that have been made by the series of blades. Also the downward pulling of the carcass by the disc tends to rotate the legs upward with respect to the back portion as the hock joints are held in the shackle such that the joint between the upper thigh and the back portion is rotated causing a dislocation of the joint. The curved plow's radial distance or gap from the disk is adjustable as the curved plow is adjustably mounted by mount 504. The height of the secondary upper guide rods of the guide assembly is adjustable using mounting slots 506.

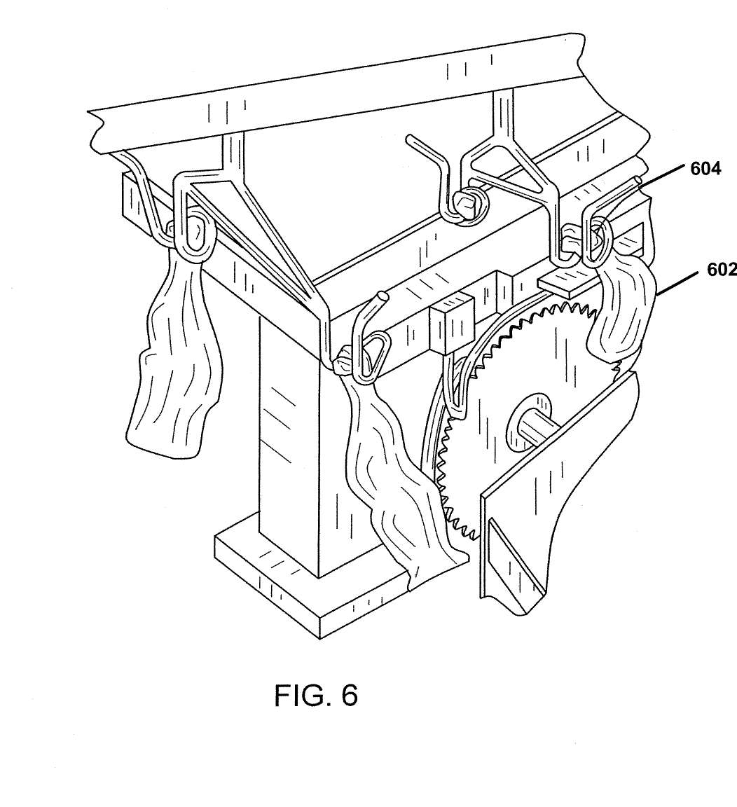

Referring to FIG. 6, a perspective view of the leg processing apparatus having a back half 602 hanging by the hock joints 604 in a shackle being conveyed through the leg processor apparatus is shown. The shackles being conveyed each have left and right hook members where the left and right leg hock joints of the back half are hung. The back half is conveyed through the leg processor apparatus such that the legs of the back half straddle the various guide members which orient the back half such that the appropriate cuts are made by the various blades. The straddling of the legs on either side of the guide members also allow the guide members to apply an outward tension at the joint between the back portion and the upper thigh of the leg quarter. This outward tension to the joint assists in separating the leg quarter from the back portion.

The process begins when the back half or the saddle has been separated from the remainder of the carcass. Once separation of the back half has occurred, the back half is hung in the shackle by the leg hock joints where the hooks of the shackle adequately separate the legs such that they will straddle the guide members of the leg processing apparatus. The shackles are conveyed along an overhead conveyor rail that has a conveyance path that extends above and along the length of the leg processor. The conveyor rail is substantially centered over the leg processor such that the legs will straddle the guide members of the leg processor apparatus and the back portion will be centrally oriented over the leg processor. The overhead conveyor rail is also at the appropriate height such that the back portion of the back half will enter the leg processor apparatus between the upper and lower guide members. The guide members of the leg processor apparatus provide an adequate opening between the upper and lower guide members such that back halves of somewhat varying size will be appropriately received between the upper and lower guide members.

The leg processor receives the back half such that the back portion is received between the upper and lower guide members and the leg quarters straddle the guide members on either side. The guide members center the back half and holds down the back half for engaging the various blade members. The guide members also apply an outward tension at the joint between the upper thigh and the back portion by having a progressive outward cant. The back portion of the back half passes over various blades which progressively sever the leg quarters from the back portion.

After the final cut is made the back half travels along the exit end under the upper secondary guide member assembly where the opposing sides of the upper guide member assembly curve outward away from one another in a butterfly wing type pattern pulling the leg quarters outward away from the back portion. Concurrent with the pulling action of the guide member, the disc having peripheral teeth grabs the back portion and pulls it downward to engage the curved plow member having a v-shaped cross section and rotates the leg quarters upward about the joint between the leg quarter and the back portion, which completes the separation of the leg quarters from the back portion. Once separation has occurred the leg quarters continue along the conveyance path hanging in the shackles by their respective hock joints. The separated back portion falls downward for subsequent processing. FIG. 6 depicts back halves being processed on the leg processing apparatus.

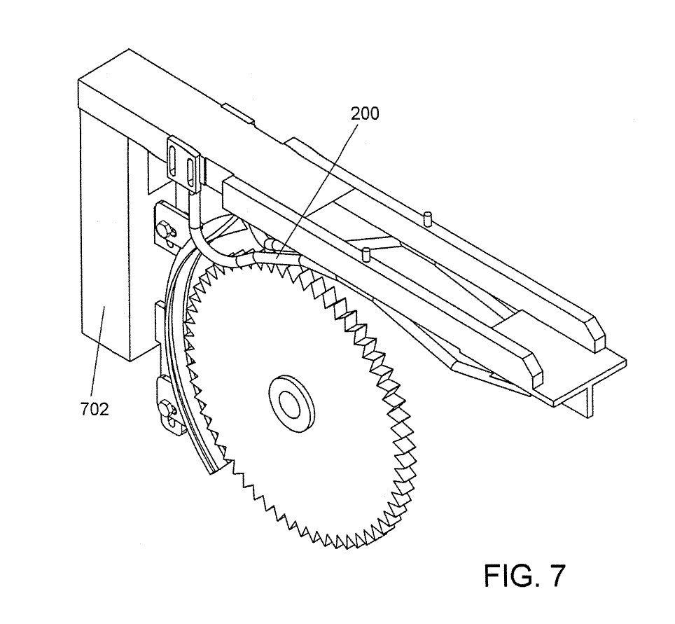

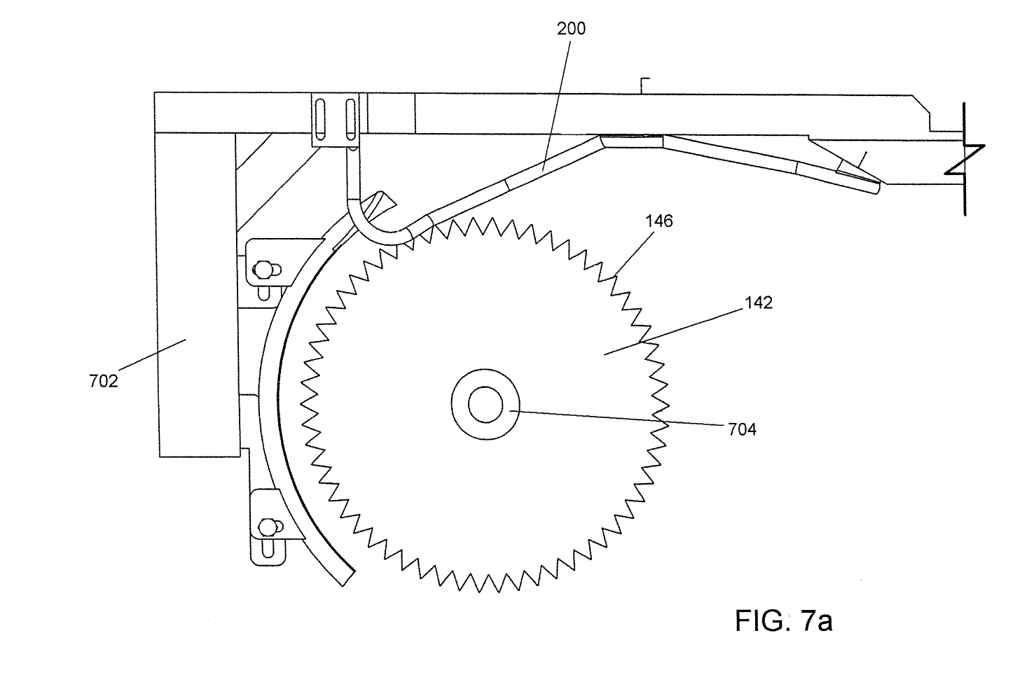

FIG. 7 shows the arrangement between the curved plow, the disc and the secondary upper guide rods. The mounting frame 702 for the curved plow assembly has adjustably mounted thereto the curved plow. The mounted position of the curved plow can be horizontally adjusted with the slotted mounting tabs, which adjusts the radial gap between the curved plow and the disc. The embodiment shown in FIG. 7 shows a curved plow that is substantially co-centric with the disc. However, depending on the application the curved plow need not be co-centric.

The guide rod member 200 is shown having a downward turn. The downward turn could be co-centric depending on the application, however the embodiment shown in FIG. 7 does not have a co-centric downward turn. The down turn of the secondary upper guide rod can be better seen by the side view shown in FIG. 7a. The down turn is more of a downward linear slope that is off set with respect to the disc 142. As a back half is pulled along the secondary upper guide rods by a shackle being conveyed along an over head conveyor rail, the downward linear slope of the guide rod pulls the back portion downward to engage the disc teeth 146. In addition to the back portion being pulled downward, the leg quarters will tend to rotate upward about the joint between the back portion and the leg quarter. This upward rotation will tend to dislocate the joint. The disc is operable to rotate about a bearing member 704 that can be axially connected to a motor or other drive.

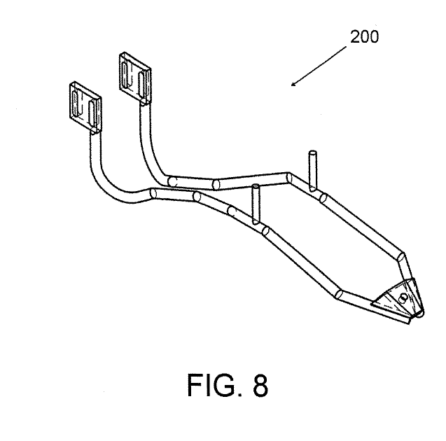

FIG. 8 shows an isometric view of the secondary upper guide rod member 200. A portion of the rod members extend substantially in parallel. The rod members then turn downward for pulling the back portion downward toward the disc and for creating tension between the whole leg and the back portion. As the rod members turn downward they also turn inward so that too much tension is not caused. The rod members then transition to the butterfly wing like structure for generating the final separation of the whole leg.

The various embodiments of the leg processor and examples shown above illustrate a novel leg processing method and apparatus. A user of the present invention may choose any of the above leg processor embodiments, or an equivalent thereof, depending upon the desired application. In this regard, it is recognized that various forms of the subject leg processor invention could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

1. An apparatus for separating leg quarters from the back portion of a poultry carcass back half comprising:
an elongated guide assembly having an entry end and an exit end mounted below a conveyor and extending along a path of conveyance and said guide assembly further having two proximately spaced guide rods for receiving and supporting a spine of a back portion of a back half thereon and straddling a circular blade and extending substantially in parallel along the path of conveyance toward the exit end beyond the blade; and
a wedge shaped plow having its peak pointing toward the entry end and each of a pair of diverging sides of the wedge shaped plow is attached to one of the rods such that the peak is centrally aligned between the two guide rods.

2. The apparatus for separating leg quarters as recited in claim 1, where the elongated guide assembly further comprises:
an upper elongated guide member having a v-shaped cross section forming a crest edge and oriented with the crest edge pointing downward for receiving the back portion of the back half there under and a left and right whole leg straddled on either side.

3. The apparatus for separating whole leg as recited in claim 2, where the upper elongated guide member having attached thereto on opposing sides outwardly angled rod members for forcing apart the left and right whole legs causing tension at a left and right thigh joint between the left and right whole leg and the back portion.

4. The apparatus for separating leg quarters as recited in claim 2, where the upper elongated guide member has an upwardly angled bend on the entry end for receiving the back half.

5. The apparatus for separating whole leg as recited in claim 1, where the approximately spaced guide rods have downward and outward bends on the entry side.

6. The apparatus for separating whole leg as recited in claim 1, where the wedge shaped plow is a v-shaped plow.

7. An apparatus for separating whole leg from the back portion of a poultry carcass back half comprising:
a disc mounted below a conveyor rail conveying poultry shackles and aligned along a path of conveyance and said disc having teeth about its peripheral extending radially outward and said disc is operatively connected to a drive for effecting rotation of the disc to grasp and pull downward a poultry carcass; and
an elongated curved plow having a v-shaped cross section mounted and aligned along the path of conveyance and extending partially around the peripheral of the disc and having a radial gap between the teeth and the curved plow.

8. The apparatus for separating whole leg as recited in claim 7, where the curved plow has a circular curve and is co-centric with the disc.

9. The apparatus for separating whole leg as recited in claim 7, where the curved plow is adjustably mounted to a frame with a horizontally adjustable mounting member adapted to variably adjust the radial gap between the teeth and the curved plow.

10. The apparatus for separating whole leg as recited in claim 7, where the curved plow has at least one pointed leading edge.

11. An apparatus for separating whole leg from the back portion of a poultry carcass back half comprising:
a disc having teeth about its peripheral extending radially outward where said disc is operatively connected to a drive for effecting rotation of the disc;
an elongated curved plow having a v-shaped cross section mounted adjacent the disc and extending partially around the disc and having a radial gap between the teeth and the curved plow; and
an elongated guide assembly having an entry end and an exit end mounted above the disc having left and right elongated guide members extending on either side of the disc in parallel over a portion of its length and further extending to turn downward toward the disc.

12. The apparatus for separating leg quarters as recited in claim 11, where the curved plow has a circular curve and is co-centric with the disc.

13. The apparatus for separating whole leg as recited in claim 11, where the curved plow is adjustably mounted to a frame with a horizontally adjustable mounting member adapted to variably adjust the radial gap between the teeth and the curved plow.

14. The apparatus for separating whole leg as recited in claim 11, where the curved plow has at least one pointed leading edge.

15. The apparatus for separating whole leg as recited in claim 11, where the left and right elongated guide members turn outward as they extend toward the exit end.

16. An apparatus for separating whole leg from the back portion of a poultry carcass back half comprising:
a frame adapted to be fixedly mounted below a conveyor rail extending along a path of conveyance and operable to convey poultry carcass shackles;
an elongated guide assembly mounted to said frame having left and right elongated guide members extending in parallel along the path of conveyance and each extending further downstream curving outward forming a butterfly wing pattern and said guide assembly is positioned such that a whole leg of an oncoming back half being conveyed in a shackle straddles the left and right guide member;
a disc having teeth radially extending outward around the peripheral of the disc and said disc and teeth oriented substantially vertical and substantially aligned with the path of conveyance and said disc rotatably mounted to said frame at a height such that the teeth engages a back portion of the back half as the disc rotates pulling the back portion along its circular path of rotation; and
an elongated curved plow having a v-shaped cross section forming a crest edge mounted to said frame and said curved plow positioned to be co-centrically oriented with the disc and proximately spaced from the disc peripheral forming a radial gap such that the crest edge of the plow plows into the back portion as it is pulled by the disc.

17. The apparatus for separating whole leg as recited in claim 16, where the curved plow is adjustably mounted to the frame with a horizontally adjustable mounting member adapted to variably adjust the radial gap between the teeth and the curved plow.

18. The apparatus for separating whole leg as recited in claim 16, where the curved plow has at least one pointed leading edge.

19. The apparatus for separating whole leg as recited in claim 16, where the elongated guide assembly is adjustably mounted to the frame such that the elongated guide members can be adjustably lowered and raised with respect to the disc.

20. The apparatus for separating whole leg as recited in claim 16, where the left and right elongated guide members turn downward toward the disc as they extend downstream for pulling the back portion downward to engage the disc.

21. An apparatus for separating whole leg from the back portion of a poultry carcass back half comprising:
a circular blade rotatably mounted below a conveyor rail conveying shackles along a path of conveyance and said circular blade is operatively connected to a drive for effecting rotation of the circular blade;
an elongated guide assembly having an entry end and an exit end mounted below the conveyor and extending along the path of conveyance and said guide assembly further having two proximately spaced guide rods extending in parallel along the path of conveyance downstream beyond the circular blade and straddling said circular blade; and
a wedge shaped plow having its peak pointing upstream and each of the slanted sides of the wedge shape plow is attached to one of the rods such that the peak is aligned with an edge of the circular blade.

22. The apparatus for separating whole leg as recited in claim 21, where the elongated guide assembly further comprises:
an upper elongated guide member having a v-shaped cross section oriented with the crest edge pointing downward for receiving a back portion of a back half there under and a left and right whole leg straddled on either side.

23. The apparatus for separating whole leg as recited in claim 22, where the upper elongated guide member having attached thereto on opposing sides outwardly angled rod members for forcing apart the left and right whole leg causing tension at the left and right thigh joint between the left and right whole leg and the back portion.

24. The apparatus for separating whole leg as recited in claim 22, where the upper elongated guide member has an upwardly angled bend on the entry end for receiving the back half.

25. The apparatus for separating whole leg as recited in claim 21, where the proximately spaced guide rods have downward and outward bends toward the entry end.

26. The apparatus for separating whole leg as recited in claim 21, where the wedge shaped plow is a v-shaped plow.

27. An apparatus for separating whole leg from the back portion of a poultry carcass back half comprising:
a frame adapted to be fixedly mounted below a conveyor rail, extending along a path of conveyance and operable to convey poultry carcass shackles;
a circular blade rotatably mounted below the conveyor rail conveying shackles along a path of conveyance and said circular blade is operatively connected to a drive for effecting rotation of the circular blade;
an first elongated guide assembly mounted to said frame below the conveyor and extending along the path of conveyance and said guide assembly further having two proximately spaced guide rods extending in parallel along the path of conveyance toward an exit end beyond the circular blade and straddling said circular blade;
a wedge shaped plow having its peak pointing toward an entry end and each of the diverging sides of the wedge shape plow is attached to one of the rods such that the peak is aligned with the edge of the circular blade;
a second elongated guide assembly mounted to said frame having left and right elongated guide members extending in parallel along the path of conveyance and further downstream curving outward forming a butterfly wing pattern and said second guide assembly is positioned such that a whole leg of an oncoming back half being conveyed in a shackle straddles the left and right guide member;
a disc having teeth radially extending outward around the peripheral of the disc and said disc and teeth oriented substantially vertical and substantially aligned with the path of conveyance and said disc rotatably mounted to said frame at a height such that the teeth engages a back portion of the back half as the disc rotates pulling the back portion along its circular path of rotation; and
an elongated curved plow having a v-shaped cross section forming a crest edge mounted to said frame and positioned to be co-centrically oriented with the disc and proximately spaced from the disc peripheral such that the crest edge of the plow plows into the back as it is pulled by the disc.

28. A method for separating whole leg from the back portion of a poultry carcass back half comprising the steps of:
cutting a back portion of a poultry carcass back half at least along the spine with a rotatable circular blade having a cutting edge;
plowing along a cut created by the circular blade, along the spine of the back portion with a horizontally oriented wedge shaped plow where said plow, having a vertically oriented peak aligned with the cutting edge.

29. The method of separating whole leg as recited in claim 28, further comprising the steps of:
pulling a whole leg of the back half outward with outwardly angled guide members about which the whole leg straddle causing outward tension.

30. The method of separating whole leg as recited in claim 28, further comprising the steps of:
receiving and aligning the back portion under an upper elongated guide member having a v-shaped cross section oriented with a crest edge pointing downward for receiving the back portion of the back half there under and with the whole leg straddled on either side.

31. The method of separating whole leg as recited in claim 28, further comprising the steps of:
receiving and aligning the spine with two proximately spaced guide rods for receiving and supporting and aligning the spine of the back portion and the rods straddle the circular blade and extend in parallel along the path of conveyance toward the exit end beyond the blade.

32. A method for separating whole leg from the back portion of a poultry carcass back half comprising the steps of:
cutting a back portion including whole legs at least along a spine forming a cut along the spine with at least one blade;
pulling the whole legs of the back portion outward by straddling the whole legs about a progressively outwardly expanding upper elongated guide member by conveying the leg quarters of the whole leg along the guide member; and
plowing along the cut along the spine of the back portion with a crest edge of a curved plow having a v-shaped cross section.

33. The method of separating whole leg as recited in claim 32, further comprising the steps of:
grasping the back portion being conveyed with a rotatable vertically oriented disc having teeth around its peripheral and pulling the back portion about the peripheral engaging the curved plow having a v-shaped cross section.

34. The method of separating whole leg as recited in claim 33, further comprising the steps of:
pulling the back portion downward with an upper elongated guide member toward the disc for grasping by conveying the back portion along the guide member having a downward bend.

35. The method of separating whole leg as recited in claim 34, further comprising the steps of:
rotating the whole leg upward about a thigh joint connecting the whole leg to the back portion by continuing to hold the whole leg in a conveyor shackle as the whole leg is being conveyed.

36. A method for separating whole leg from the back portion of a poultry carcass back half comprising the steps of:
conveying a poultry shackle along a conveyance line where said poultry shackle has a back half hanging therefrom by a pair of hock joints such that two whole legs of the back half are spread apart and straddle an elongated guide member and a back portion of said back half is positioned under the guide member; and
grasping the back portion being conveyed with a rotatable vertically oriented disc having teeth around its peripheral and pulling the back portion about the peripheral engaging a curved plow having a v-shaped cross section where the curved plow is concentrically oriented and proximately spaced with respect to the disk and the peaked edge of the plow is aligned with the disc.

37. The method of separating whole leg as recited in claim 36, further comprising the steps of:
pulling the back portion downward with an upper elongated guide member toward the disc for grasping by the disc by conveying the back portion along the guide member having a downward bend.

38. The method of separating whole leg as recited in claim 37, further comprising the steps of:
rotating the whole leg upward about a thigh joint connecting the whole leg to the back portion by continuing to hold the hock joints in a conveyor shackle.

39. A method for separating leg quarters from the back portion of a poultry carcass back half comprising the steps of:
conveying a poultry shackle along a conveyance line where said poultry shackle has a back half hanging therein by a pair of hock joints such that two whole legs of the back half are spread apart and straddle an upper elongated guide member and a back portion of said back half positioned under the guide member;
supporting the back portion with a lower guide assembly having left and right guide rods proximately spaced on either side of a circular blade;
cutting the back portion with the circular blade along a spine of the back portion by conveying over the blade to form a cut along the spine; and
plowing along the cut created by the circular blade along the spine of the back portion with a horizontally oriented wedge shaped plow, said plow having a vertically oriented peak aligned with the circular blade.

40. The method of separating whole leg as recited in claim 39, further comprising the steps of:
receiving and aligning the back portion under the upper elongated guide member having a v-shaped cross section oriented with the crest edge pointing downward for receiving underneath the back portion of the back half as the back portion is being conveyed.

41. The method of separating whole leg as recited in claim 39, further comprising the steps of:
receiving and aligning the spine of the back portion between the left and right guide rods.

42. A method for separating whole leg from the back portion of a poultry carcass back half comprising the steps of:
cutting a back portion of a back half at least along the spine with at least one blade;
plowing along a cut created by at least one blade along a spine of the back portion with a horizontally oriented wedge shaped plow where said plow, having a vertically oriented peak aligned with a cutting edge of the at least one blade;
pulling a pair of whole legs of the back portion outward by straddling the whole legs about a progressively outward expanding guide member and conveying the whole legs along the guide member;
grasping the back portion being conveyed with a rotatable vertically oriented disc having teeth around its peripheral and pulling the back portion about the peripheral such that the cut along the spine engages and is plowed by a curved plow having a peaked edge and having a v-shaped cross section where the curved plow is concentrically oriented and proximately spaced with respect to the disc and the peaked edged of the plow is substantially aligned with the edge of the disc.
